(19) United States
(12) Patent Application Publication
(10) Pub. No.: US 2009/0223128 A1
(43) Pub. Date: Sep. 10, 2009

(54) Hydroponic Monitor And Controller Apparatus with Network Connectivity and Remote Access

(76) Inventor: Brian C. Kuschak, Sunnyvale, CA (US)

Correspondence Address: Brian Kuschak, BK Innovation, Inc., Suite 14, 1016 Morse Ave., Sunnyvale, CA, 94089, US

(21) Appl. No.: 12/396,058

(22) Filed: Mar. 2, 2009

Related U.S. Application Data
(60) Provisional application No. 61/034,360, filed on Mar. 6, 2008.

(51) Int. Cl. A01G 31/02; A01G 31/00; G05D 27/00

(52) U.S. Cl. 47/62 N; 47/62 R

(57) ABSTRACT

An apparatus for monitoring and controlling a hydroponic installation which measures various sensors, controls electrical devices, and provides a rich user interface through a standard web browser accessible anywhere on the Internet. Network connectivity allows the operator to manage the system remotely, as well as view recent and historical data through web pages. Digital cameras, of the kind typically used with PCs, provide visual feedback. The apparatus can notify the operator in the case of certain predetermined conditions, using a variety of messaging methods, including email, SMS or MMS page. The operator can remotely initiate control through reply messages. An industry-standard expansion bus provides the ability to attach external devices for additional functionality. Network access can be provided by Ethernet, Wi-Fi, or a nearby cell phone with Bluetooth.

### REFERENCES SITED

### U.S. PATENT DOCUMENTS

U.S. Pat. No. 4,015,366 Highly Automated Agricultural Production System
U.S. Pat. No. 4,742,475 Environmental Control System
U.S. Pat. 4,992,942 Apparatus and Method for Controlling a system such as nutrient control system for feeding plants, based on actual and projected data and according to predefined rules.
U.S. Pat. No. 5,771,634 Hydroponic Control Apparatus, expired as of 2002.
U.S. Pat. No. 7,229,026 System and method for use in controlling irrigation and compensating for rain

### BACKGROUND OF THE INVENTION

1. Field of the Invention

The present invention relates to the practice of plant growth in soilless or reduced-soil media, commonly known as hydroponic cultivation, and in particular to the monitoring of environmental and system parameters involved in hydroponic cultivation, and the electrical control of devices used in the hydroponic installation.

2. Description of the Prior Art

Hydroponic cultivation has found favor with growers due to the increased crop yields and plant health compared to traditional plants grown in soil conditions. Plants are fed a nutrient solution and are commonly kept in a controlled environment. While hydroponic cultivation has advantages over traditional plant growth techniques, it requires a more complex infrastructure to achieve good results. There is a requirement to maintain liquid nutrient parameters in a narrow range of preferred values for optimal growth. These parameters include nutrient temperature, pH, and concentration (typically measured by electrical conductivity (EC)). If the parameters drift outside the desired range, the plants can harmed. There are additional parameters which can be adjusted to further optimize growth, such as air temperature, relative humidity, light intensity, and carbon dioxide (CO2) concentration.

The hydroponic installation typically uses electrically-driven pumps, valves, and actuators to adjust nutrient flow, concentration, and composition. Other electrical devices are used to adjust light intensity, such as High-Intensity Discharge (HID) lamps and light-mover machines. Air and nutrient temperatures are adjusted through the use of heaters, chillers, fans or blowers, and air vents. CO2 concentration and relative humidity may also be adjusted by electrical actuators. Some devices are best operated on a fixed daily schedule, such as HID lamps or heaters. Other devices are best operated in response to actual measured system parameters, such as dosing of pH control solution or concentrated nutrient solution.

The operator thus has the task of monitoring and controlling a variety of system parameters to achieve the best conditions for the specific plants in the installation. This can be time consuming. A failure to properly control the parameters may result in plant harm and financial loss. Additionally, if a component failure occurs while the operator is not on site, it may be detected too late to prevent harm. Component failures such as leaks, failed pumps, faulty temperature control devices or faulty lamps can occur at any time.

Often, it is financially advantageous to ensure the plants are growing at the fastest rate possible using the least amount of resources. This often requires detailed analysis of present and historical data, looking for trends between nutrient and environmental conditions and plant response. This requires keeping accurate measurements of measured conditions and a method of recording plant growth and behavior, typically over the course of one or more growing seasons. Conventionally this is done by keeping records by hand, and requires additional time and effort, with the possibility of mistakes.

Some hydroponic installations are exposed to the outside environment, and are therefore not in a completely controlled environment. They may receive natural sunlight and supplementary irrigation from rainwater. To achieve optimal growth, the hydroponic system parameters should be adjusted in response to the weather at the hydroponic installation. Some weather conditions, such as very high temperatures can cause stress on plants which can decrease their growth and yield, or make them more susceptible to attack by pests. It is known by those skilled in the art that changing nutrient composition during these times can improve plant resilience. For example, adding silicon ions to the nutrient solution can help plants survive better in hot weather.

Those skilled in the art will recognize that various products are available which attempt to provide some of these capabilities. These products typically take the form of computerized hydroponic and greenhouse controllers, automated feeders and dosers, and pH/conductivity/temperature monitors and data loggers. For example, U.S. Pat. No. 5,771,634, Hydroponic Control Apparatus, now abandoned, teaches a self-contained apparatus which combines the features of multiple electrical sensors, electrical output control, and both manual and computer-control of outputs for control of a hydroponic garden. However, said invention describes a very limited user-interface, consisting of a small liquid crystal display (LCD) and keyboard which requires the user to sequentially step through a list of 20 to 30 individual sensors and outputs. The user must be physically present in front of the device to operate this interface, and display information is limited to 40 alphanumeric characters.

Several products now on the market offer similar features with limited user interface, including the Extreme Greenhouse Controller from Custom Automated Products of Riverside, Calif. This product allows timer-based control of multiple electrical outlets, temperature and humidity sensors and output control, and CO2 sensing and control. However, this product also has a rudimentary user-interface, comprising knobs, dials, and switches. It requires the operator to be physically present to configure the device, and lacks a display unit on which to display dynamic information. It does not offer remote access or administration, nor does it have the ability to notify the operator remotely. The iGrow 1400 Greenhouse controller, manufactured by xxxx, performs similar functions, and also captures sensor data to memory which can then be transferred to a personal computer for further data analysis. The ability to farther analyzes this data adds value for the operator, but having a similar user interface of small LCD screen and front panel buttons, this controller suffers from the limitations described above. This controller also does not have a remote access capability.

There are commercially available products to monitor hydroponic nutrient condition, such as pH and EC. An example is the GroCheck pH/TDS Monitor, manufactured by Hanna Instruments of Woonsocket, R.I. Some competing products can also control the addition of nutrients, such as the DoseTronic 2000 Controller, manufactured by Cotswold Hydroponics, Ltd. of New Zealand. These and similar products offer the grower the ability to monitor nutrient condition over long time periods, and may offer the ability to dose nutrient solutions in response to changes in the hydroponic nutrient condition, however they too suffer from a limited user interface, and require the user to be physically present to configure the device and read the current measurements.

U.S. Pat. No. 4,992,942 teaches the use of mathematical techniques in probability and artificial intelligence to control a nutrient dosing system for plants. That system determines how best to dose the nutrient, to achieve a desired target nutrient level at a projected future time. The present invention does not use such techniques as it simply allows the operator to set thresholds at which point specific operations are performed. This has been found effective for most control tasks.

### SUMMARY OF THE INVENTION

The present invention improves the situation for the hydroponic cultivator in a number of ways. Firstly, the invention monitors all the environmental and system parameters frequently, and stores a historical record of these measurements for later analysis. Secondly, it controls electrical devices both on fixed schedules and in response to measured environmental and system parameters. Thirdly, it allows the operator to remotely access, control, and monitor the hydroponic system through a rich and intuitive user interface, accessible from potentially anywhere in the world. Fourthly, it can automatically notify the operator in real-time or near-real-time when any system parameters drift outside the range of preferred values. Lastly, by virtue of being connected to other networked computer systems, it can retrieve updated forecasts of local weather conditions which can then be used to further adjust control of system parameters, useful if the hydroponic installation is not isolated from the natural environment.

The invention achieves all these capabilities while retaining a physically small form factor, and is easily integrated into the hydroponic installation in a manner similar to the existing art.

The invention uses an array of sensors, such as a pH electrode, electrical conductivity (EC) probe, and thermistor or resistance-temperature-detector (RTD) to measure nutrient parameters. It uses solid-state sensors to measure environmental conditions such as air temperature, relative humidity, CO2 concentration, and light intensity. It also has general-purpose electrical inputs to measure sensors such as liquid-level float switches, water depth sensor, security sensors, fan tachometer, and any other sensing device which can produce a low-voltage digital or analog output signal. To operate electrical equipment such as HID lamps, pumps, fans, blowers, or nutrient dosers, the invention includes multiple electrical relays which can each switch standard AC mains voltage, such as 120 VAC/240 VAC at 50/60 Hz. The invention further senses the amount of AC mains power consumed by the attached electrical equipment, and keeps a running total of kilowatt-hours of electrical energy used. Additional electrical relays are included to switch low-voltage loads such as solenoid valves, actuators, and other devices which operate on 24 volts or less. Present and historical measurements and control activity are stored in the internal memory of the present invention, or external memory connected to an expansion port, such as a Universal Serial Bus (USB) memory stick, commonly used with personal computers. This data can be further analyzed by the operator to detect trends throughout the growing season.

The user interface is not restricted to a small LCD screen or alphanumeric display with buttons and knobs. Rather, the primary user interface is a standard World-Wide-Web Browser (web browser), of the kind typically found on personal computers for browsing the Internet. To accomplish this, the invention contains a network interface device such as an Ethernet port, which is connected to the operators' local area network (LAN) or directly to a personal computer equipped with Ethernet. As such, the user-interface for the present invention appears as just another Internet web-site, which is accessible via said web browser. All configuration, status information, and present and historical measurements of system parameters are available through the web browser, using multiple web pages, connected together to form a comprehensive web site. This allows for a rich and intuitive interface between the operator and the invention, complete with text, graphics, and multimedia content. As an example of the utility provided by this type of interface, the invention may provide a frequently updated graph of pH, nutrient concentration (EC), temperature, relative humidity, light intensity, and AC power consumption over the past 24 hours or 7 days. Preferred ranges are highlighted in specific colors or patterns, while any measurements outside of the preferred range are clearly identified in another color or pattern. The operator can quickly see trends among the different parameters. Another web page may be used to configure the fixed schedule for electrical devices which are operated on timers. Instead of adjusting a small knob on a front panel, which may be difficult to see or operate, various timer schedules can be set and viewed with the click of a mouse. Timer schedules and past activity may be displayed in a bar-graph along a time-axis, with different colors for each device. Similar intuitive web pages may be used for any of the other functions provided by the invention. This web browser interface greatly simplifies the task of configuring the invention for the demands of a particular hydroponic installation.

If the LAN has connectivity to the Internet, as is typical in many homes and commercial buildings, the present invention can be configured to be accessible from anywhere on the public Internet. No longer does the operator have to be on-site to check the status of their hydroponic system parameters, or operate electrical equipment or control various system devices. In this case, all monitoring and control is accessible via the Internet and a web browser from potentially anywhere in the world. It should be noted that the invention may contain wired Ethernet as well as a wireless network interface such as Wireless Fidelity (Wi-Fi). Publicly accessible Wi-Fi networks are becoming commonly available in many cities and some outlying areas. This ability to connect to wireless networks further simplifies integration of the present invention in a greenhouse or garden environment, where wired network cabling may not be available or desired.

Once network connectivity has been established, the invention provides many benefits that do not existing with the prior art. Remote control and monitoring has been described. Remote notification is also possible. The operator can configure the device to notify him or her of the existence of any undesired conditions, such as nutrient concentration too low, or temperature too high, or a low light level due to a faulty lamp. Surely, one skilled in the art can conceive of other conditions in the hydroponic installation which would merit notification of the operator. The notification takes the form of Electronic Mail (email), Short Message Service (SMS) text page, or Multimedia Messaging Service (MMS) message. These notifications can be retrieved by the operator through typical means such as using an email client program, checking an Internet web site, or using a cell phone which can receive SMS or MMS messages or email. If the operator chooses to be notified by SMS message to a cell phone, they can be notified in real-time or near-real-time of any conditions in the hydroponic installation that warrant their immediate attention. This capability allows the operator to respond promptly to remedy a situation which might otherwise cause plant harm or financial loss. Prior art hydroponic and greenhouse controllers lack this important distinguishing feature.

The present invention also has the ability to query Internet time servers to ensure that the internal clock is always correct, including changes due to daylight savings time (DST), and any time errors which might occur due to a power outage in the hydroponic installation.

Email can also be used to send the previously recorded measurement data on internal or external memory to the operator's email account. This provides another way to archive measurement data which can then be further integrated into a data analysis or tracking system.

With Internet connection, additional capabilities become possible. For example, an Internet web site or service can be checked by the apparatus, periodically, to retrieve the latest weather forecasts. These forecasts can be used to alter the control of equipment to allow the plants to respond better to environmental conditions. An earlier example was cited, where nutrient flow might be adjusted in anticipation of heavy rain, or nutrient composition might be altered to better respond to hot conditions which would otherwise stress the plants.

To complement the sensors which measure environmental and hydroponic system parameters, the invention supports the addition of external devices to the USB expansion bus which further add value for the operator. For example, one or more USB camera devices, of the kind that are designed for use with personal computers, can be connected to the USB bus of the apparatus. These USB cameras, also known as webcams, can capture digital still images and digital video, with or without audio, and transmit it over the USB bus to a computer. The present invention uses the camera(s) to take snapshots of the plants or other parts of the hydroponic installation at fixed intervals, or in response to the operator's request via the web site. This provides visual feedback to the operator of conditions in the installation, complementing the information from other sensors. Periodic snapshots can be combined together over the course of the growing season to create a time-lapse motion picture of the plant growth over time. Optionally, the system parameters can be added as text or graphics overlay on each of the camera images to show correlation between system parameters and actual plant growth and response. Such a feature gives the operator a clear, intuitive understanding of how the plant responds to its environment. Time-lapse motion pictures illustrate subtleties which can be missed by examining plant physiology on a daily basis, since changes may occur very slowly. Examining such time-lapse evidence could enable the operator to further optimize their resource usage, and hence increase profitability. Additionally, the USB cameras can be directed to capture segments of digital video, at a frame rate sufficient to show smooth motion, for display on the web pages. This can provide visual feedback to the operator of dynamic conditions at the hydroponic installation, such as the effects of air movement, changing light, or running water.

For all the reasons stated, it will become clear to someone skilled in the art, that the present invention offers a variety of benefits that are not currently available, with the technology of the prior art. These include direct benefits to the grower, including optimized plant growth, resource efficiency, reduced effort, and nearly immediate knowledge of conditions which may harm plant health and reduce crop yields.

### DETAILED DESCRIPTION OF THE PREFERRED EMBODIMENTS

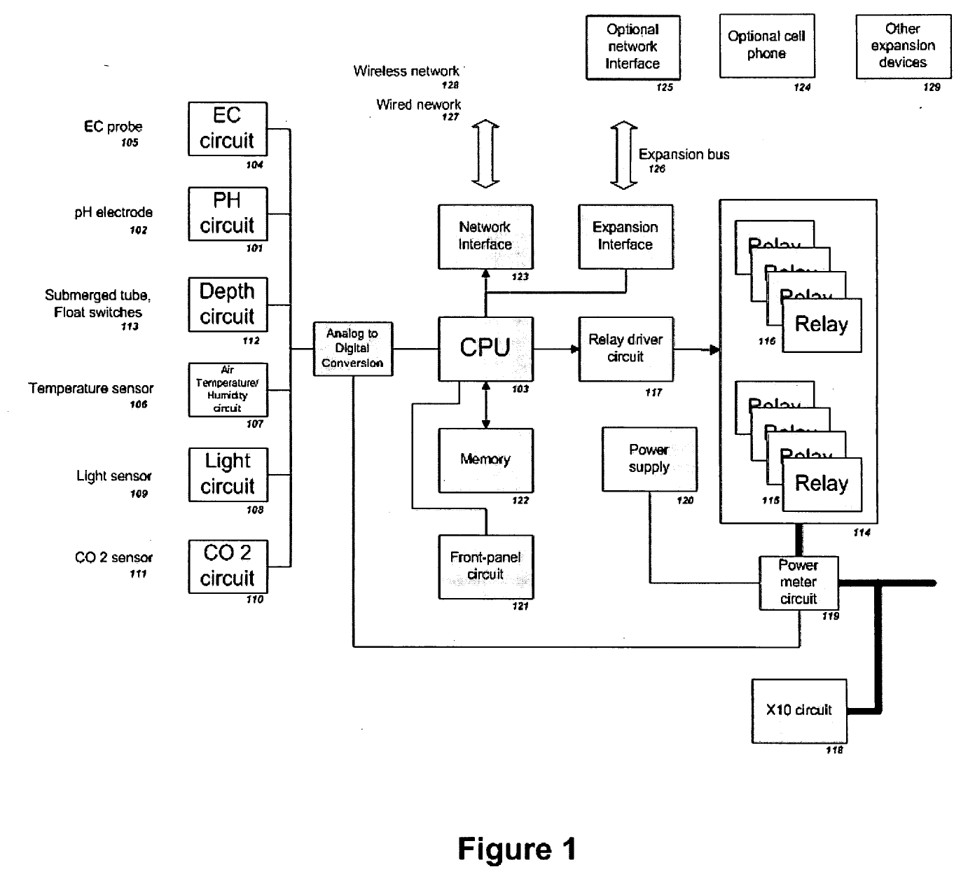

FIG. 1 is a block diagram of the electrical hardware of the present invention. Apparatus hardware includes analog and digital circuitry which is dedicated to each of the following tasks. PH circuit 101 reads the voltage generated by the pH probe electrode 102 (used to measure nutrient acidity or alkalinity) and converts this analog voltage into a digital binary number representation, using one of the methods well known to those skilled in the art of electronic circuitry design. In the preferred embodiment, an Analog to Digital Converter (ADC) integrated circuit is used to accurately measure the voltage, which is then read by the CPU 103. The pH probe 101 is electrically isolated from the pH circuit except when actually making measurements. EC circuit 104 connects to a two terminal or four terminal electro-conductivity probe 105 of the kind commonly used in hydroponic nutrient instruments. The EC circuit 104 produces an output which varies according the nutrient concentration. Since apparent concentration can be affected by temperature, it also reads the temperature of the nutrient solution, and produces an output which varies in fixed relation to the measured temperature. The EC probe 105 is electrically isolated from the EC circuit 104 except when actually making measurements, at which time it presents high impedance at low frequencies. The temperature sensor probes 106 are electrically isolated by design of their packaging, and read by a circuit 107 which produces and output which varies according to measured temperature, of both nutrient and air. The light meter circuit 108 reads a light sensor 109 whose electrical properties change in fixed relation to the intensity of light falling on it. Some light sensors which may be used are the CdS photocell, silicon photodiode, and other specialized analog or digital sensors designed for this purpose. Preferably the light sensor should have a response close to the absorption wavelengths of the plants being grown. (CdS photocell has a wide dynamic range and a response similar to the human eye, but contains cadmium which is restricted in some countries.) In the preferred embodiment, the EC 104, temperature 107, and light 108 circuits each produce a square wave of variable frequency, which is read by the CPU 103. Analog to digital conversion is performed by means of measuring the frequency by counting CPU 103 clock cycles. This method achieves high resolution with low cost. Air temperature and Humidity circuit 107 reads a solid state sensor or sensors and produces analog or digital outputs corresponding to air temperature and relative humidity. The preferred embodiment uses a specialized digital circuit designed for this purpose which produces a digital data stream read by the CPU 103. However, other sensors can be used which require the use of analog circuitry to measure a change in electrical properties. The CO2 circuit 110 detects voltage changes in a CO2 gas sensor 111, and produces an output which varies in relation to the parts per million concentration of gaseous CO2 in the air. This is the read by the CPU 103. More sophisticated sensors to measure CO2 concentration might have a digital interface to the CPU 103. A depth circuit 112 measures water or nutrient depth by measuring the air pressure in an open ended tube submerged to the bottom of the tank. The other end of the tube leads to a MEMS-type air pressure sensor. This sensor 113 produces an electrical output that varies linearly with water depth, and is measured with an ADC that is read by the CPU 103. Besides the MEMS air pressure sensor, there might be electrical float switches 113 which are activated when the nutrient or water depth exceeds the level at which the float is installed.

In addition to sensor circuitry, there are electrical relays 114 which are used to switch AC mains and low voltage electrical power to external devices. The AC mains relays 115 are capable switching up to the maximum power supplied by the AC line, typically at least 15 Amperes at 120 VAC. Ideally the relays can switch up to 20 Amperes at 240 VAC. The low voltage relays 116 are used to switch low voltage such as 24 V AC or DC. The relays 115 and 116 are controlled by the CPU 103, through a driver circuit 117. Although relays are used in the preferred embodiment, it is understood that other means of switching electrical power may be substituted, like opto-electronic driven silicon devices such as triacs, and isolated transistor bidirectional switches.

In another embodiment, the apparatus includes an interface circuit 118 for industry-standard X-10 automation modules. The electrical control means is provided by commercially available AC outlets which are controllable by sending data signals over the AC mains itself, thus enabling the apparatus to switch electrical power to a large number of devices distributed throughout the hydroponic installation. In that embodiment, the apparatus sends X-10 control messages to the modules, directing them to switch electrical power on or off, rather than using relays inside of the apparatus itself.

A power meter circuit 119 produces an output which varies in relation to the total amount of AC mains power flowing through the apparatus. This circuit may comprise a dedicated digital microcontroller which accurately measures the AC voltage and current and computes the mathematically real AC power used, similar to what is measured by the electricity provider. The relays 115 provide electrical isolation from the AC mains, and the power meter circuit 119 is electrically isolated from the CPU by optical or magnetic means.

A power supply 120 provides electrical power for the apparatus. Either AC mains or battery power may be used, but preferably an isolated switching power supply is connected to the AC mains. In this case, the electrical power measured by the power meter circuit 119 includes the power used by the apparatus itself.

A front-panel circuit 121 provides a supplementary interface to provide some level of operator control via the front panel of the apparatus. This includes buttons and indicator lamps for each of the electrical output controls. It also includes status lamps for power and alert conditions. It may also include a means of generating an audio signal to alert the user of important status changes.

The CPU 103 is connected to memory 122 used for data and program storage. Both volatile and non volatile memory is used. The CPU 103 is also connected to a network interface 123 of the type used for data communications, such as Ethernet, Wi-Fi, or HomePlug. The network interface may require dedicated wiring such as wired Ethernet, or it may use the said AC mains power line for communication such as HomePlug. It may use a radio transceiver for communication as in the case of Wi-Fi or Bluetooth. If a Bluetooth network interface is used it is possible to use a nearby cell phone 124 equipped with Bluetooth and Internet access as a means to provide network access to the apparatus. Alternatively, some cell phones can provide Internet access to the apparatus by connecting them to the USB expansion bus. Since cell phone service is widespread and has growing data communications capability, this network interface method provides a means for the operator to access the apparatus if other network connectivity is not available. A provision is made to allow the operator to connect an external network interface 125 to the USB expansion bus 126. The network interface 123 or 125 provides the data communication path for LAN and Internet access. It should be noted that more than one network interface may exist. For example, an Ethernet network interface 127 is present in the preferred embodiment, but may be Wi-Fi 128. In either case, the operator may connect a Bluetooth network interface 125 to the expansion bus. In this case, one or more of the network interfaces will be used for Internet access.

It should be noted that some free public Wi-Fi networks and some cell phone networks will not assign publicly accessible Internet addresses, in which case the operator can remotely interact with the apparatus only using communication methods that are initiated by the apparatus, such as email. By checking and sending email through a third-party email server, the apparatus can communicate with the operator indirectly, without requiring a publically accessible Internet address.

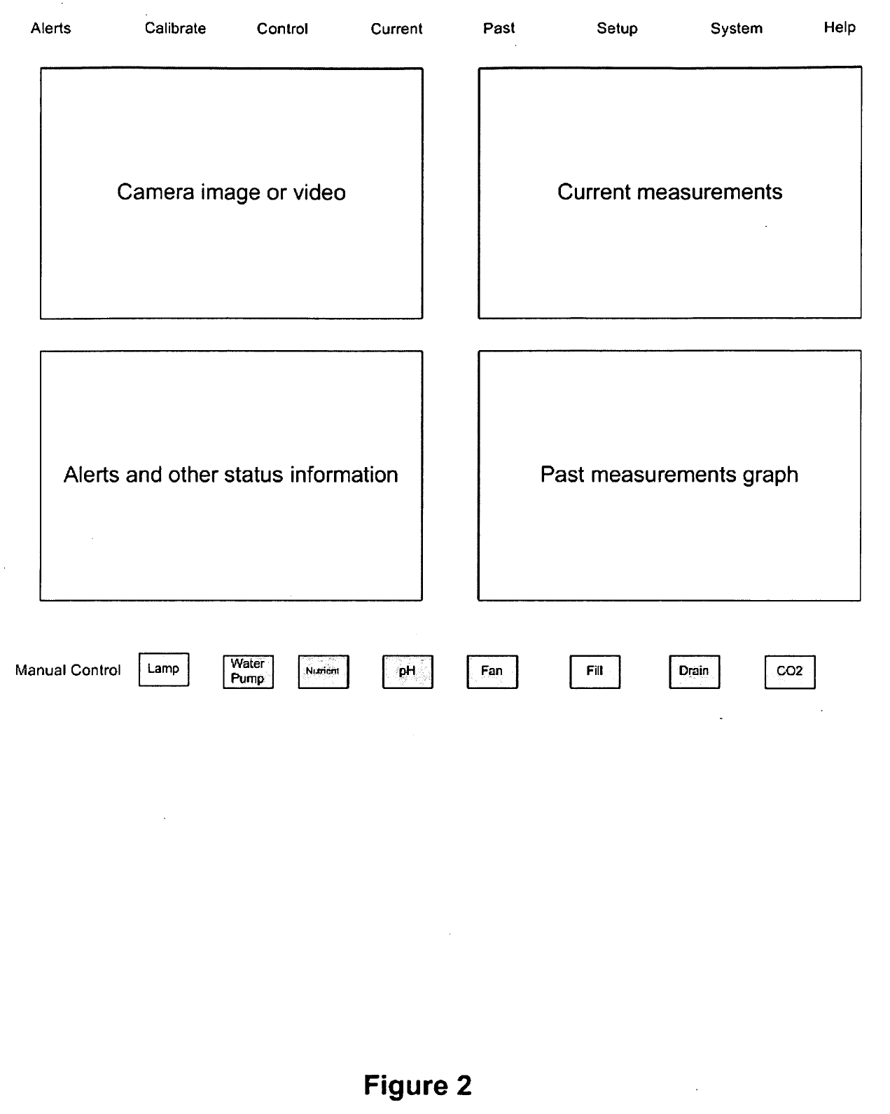

The CPU 103 executes software which manages all the hardware previously described. This software requires the following components: data processing for the sensor measurements, timers and state machines to control the external electrical devices, network interface protocols (TCP/IP stack, Wi-fi, Bluetooth protocols), software to implement the user interface, a web server for the user interface, email sending and retrieval, device drivers for the expansion bus devices, sensor calibration software, configuration storage and retrieval, data export for external storage and analysis, clock management, software-update retrieval and installation, still image and video processing software for the optional camera(s). The apparatus software might include an operating system. In the preferred embodiment, a Linux-based operating system is employed, customized for the specific combination of CPU 103 and memory 122. This operating system includes device drivers, network interface protocols, file system, and other components. User interface software creates dynamic HTML web pages whose content is created to reflect the current state of the system. An example of one of the web pages is shown in outline form in FIG. 2.

The web server provides the means for the operator to access and control the device through an Internet URL. The apparatus software might include support for Dynamic DNS. This technique, known to those skilled in the art of Internet communications, allows the apparatus to register itself with a DNS server to provide network access to the apparatus using a pre-determined Internet URL. This URL can be used by the operator to easily access the system via the web browser, even if the underlying network address changes. This is particularly advantageous if the operator attempts to access the system remotely, from the Internet.

Optional network protocols provide additional features: Simple Network Management Protocol (SNMP), Network Time Protocol (NTP), Universal Plug and Play (UPnP).

The software also includes a journal or web-log for archiving of operator notes and annotations, along with time-stamped detailed environmental and system conditions, images, time-lapse photography, or video. This allows thorough analysis of plant growth in response to changes in nutrients or environmental conditions over time, to help attain the highest level of growth from the plants. It provides an interface familiar to Internet users, and allows the operator to easily recall past activity and see how it correlates with their control actions. Web-browser interface allows much richer and more intuitive presentation of information, compared with small LCD screens on prior art controllers. Web authentication methods, well known to those skilled in the art, implement multiple levels of access control (garden administrator, technicians, casual browsers), so each has appropriate level of access to and control over the system, while blocking access to those not authorized.

What is claimed is:

1. An apparatus for monitoring and controlling hydroponic cultivation, comprising:
A means of measuring nutrient parameters such as concentration, pH, and temperature;
A means of controlling electrical devices, actuators, valves, or pumps by means of switching a source of electrical power on and off,
A means of connecting to a computer data network and transferring data over this network to and from other computer systems;
A means of providing a user interface accessible via a world-wide-web browser software program communicating over the computer data network;
A means of allowing the operator to observe present and past measured parameters via said user interface;
A means of allowing the operator to direct the control of said electrical devices via said user interface;

2. The apparatus of claim 1, where the computer data network is the global Internet.

3. The apparatus of claim 1, where the computer data network is a digital cell phone network.

4. The apparatus of claim 1, further comprising a means of measuring the depth of nutrient solution in the reservoir or root zone.

5. The apparatus of claim 1, further comprising a means of connecting one or more digital cameras to the apparatus, to be viewed via said user interface.

6. The apparatus of claim 1, further comprising a means of measuring the amount of electrical power consumed by the apparatus itself, and by the devices for which it is controlling electrical power.

7. The apparatus of claim 1, further comprising a means of sending a notification message to the operator of the apparatus, using said computer data network.

8. The apparatus of claim 7, where the notification method is email.

9. The apparatus of claim 7, where the notification method is short message service (SMS) or multimedia message service (MMS).

10. The apparatus of claim 7 where the apparatus can receive instructions in a reply message sent by the operator in response to the notification message, and act on said instructions.

11. The apparatus of claim 7, where the notification is sent whenever any of said measured parameters are outside of a range specified by the operator;

12. The apparatus of claim 1, where the electrical power is switched using a predetermined time scheduled.

13. The apparatus of claim 1, where the electrical power is switched in response to changes in nutrient conditions.

14. The apparatus of claim 1, where the electrical power is switched in response to changes in one or more environmental conditions of air temperature, relative humidity, light intensity, carbon dioxide concentration.

15. The apparatus of claim 1, where the means of connecting to the computer data network is Ethernet.

16. The apparatus of claim 1, where the means of connecting to the computer data network is Wireless Fidelity (Wi-Fi).

17. The apparatus of claim 1, where the means of connecting to the computer data network is Bluetooth.

18. The apparatus of claim 1, where the means of connecting to the computer data network is through an AC mains based networking protocol.

19. The apparatus of claim 1, where the user interface is protected by an authentication mechanism to permit only authorized users to access the system.

20. The apparatus of claim 1, further comprising a means of storing said measurements to a memory device for later presentation to the operator;

21. The apparatus of claim 1, further comprising a means of connecting external electronic devices to the apparatus, through an expansion bus.

22. The apparatus of claim 21, where the expansion bus is Universal Serial Bus (USB).

23. The apparatus of claim 21, where the expansion bus is IEEE-1394.

24. The apparatus of claim 21, where the expansion bus is Secure Digital Input Output (SDIO).

25. The apparatus of claim 1, where the means of controlling electrical devices include the use of industry-standard X-10 automation modules.

26. The apparatus of claim 1, further comprising a means of registering the network address of the apparatus in a way that makes it accessible to said web-browser through the use of an Internet URL that is not limited to IP address, and remains fixed even if the IP address changes.

27. The apparatus of claim 1, further comprising a means of retrieving information from the Internet and using said information to modify the content displayed on said user interface.

28. The apparatus of claim 1, further comprising a means of retrieving information from the Internet and using said information to modify the control of said electrical devices.

29. The apparatus of claim 1, further comprising a means for the operator to insert comments or annotations to be recorded and stored for later observation.

30. The apparatus of claim 29 where said comments are associated with measurements taken at the time they are entered and stored along with said comments.
